(19) United States
(12) Patent Application Publication
(10) Pub. No.: US 2005/0074561 A1
(43) Pub. Date: Apr. 7, 2005

(54) Method for forming film

(75) Inventors: Tatsuo Tabaru, Saga-ken (JP); Kazuhisa Shobu, Saga-ken (JP); Hisatoshi Hirai, Saga-ken (JP); Michiru Sakamoto, Saga-ken (JP)

Correspondence Address: SUGHRUE MION, PLLC, 2100 PENNSYLVANIA AVENUE, N.W., SUITE 800, WASHINGTON, DC, 20037, US

(73) Assignee: NATIONAL INSTITUTE OF ADVANCED INDUSTRIAL SCIENCE AND TECHNOLOGY

(21) Appl. No.: 10/765,831

(22) Filed: Jan. 29, 2004

(30) Foreign Application Priority Data
Jan. 30, 2003 (JP) 2003-022778

(51) Int. Cl. B05D 1/08

(52) U.S. Cl. 427/446

(57) ABSTRACT

A method for easily and uniformly forming a film at a low cost, which is comprising a diffusion-barrier layer 3 and a coating layer 4, on a surface of a substrate 1. The method has a preliminary oxidation step of forming a substrate oxide layer 2 by oxidizing the substrate 1, and a step of coating the surface thereof with a coating material containing at least one alloy or a compound, which includes an element forming an oxide having a low enthalpy of formation as compared to that of the oxide of the substrate oxide layer 2, and as a result.

### TECHNICAL FIELD OF THE INVENTION

The present invention relates techniques for forming a film, which has an intermediate layer, on a surface of a substrate. In more particular, the present invention relates to a method for forming a film, which has heat resistance and oxidation resistance, on a surface of a heat resistant material. Furthermore, in more detail, in order to prevent a heat resistant material used as a substrate from being oxidized, the present invention relates to a technique of imparting oxidation resistant properties by coating a surface of the substrate with a material comprising at least one of an alloy, an intermetallic compound, and a ceramic, each of which is capable of forming an aluminum oxide film in a high-temperature oxidizing atmosphere. Hence, the present invention can be applied to members used for high temperature applications, such as power generation turbines, and combustion chambers and turbines for aircraft engines.

### BACKGROUND OF THE INVENTION

Heat resistant materials having high temperature strength and superior oxidation resistance, such as a nickel-base superalloy, have been used as materials for power generation gas turbines and aircraft engines. In order to obtain higher energy efficiency in these combustion mechanisms, various researches and developments have been carried out for improving a heat resistant temperature of materials. As a result, in recent years, a single crystal nickel-base superalloy has been used in practice. The heat resistant temperature thereof can reach 1,075° C. In consideration that the melting point of nickel is 1,455° C., it has been believed that the heat resistant temperature described above has already reached a maximum level.

Accordingly, development of a novel heat resistant material which may replace a nickel-base superalloy has been increasingly desired. Research has been intensively carried out on intermetallic compounds, ceramics, or various structural heat resistant materials primarily comprising a high melting point metal having a melting point higher than that of nickel. However, as of today, a novel heat resistant material which can replace a nickel-base superalloy has not come in practice.

Although essentially having superior high temperature strength and oxidation resistance, the intermetallic compounds and ceramics mentioned above are brittle at low temperatures. The most serious problem thereof is poor reliability as an engineering material. Various researches have been carried out for many years, however, it has been found that it is fundamentally difficult to overcome the problem, and hence they have not been widely used in practice. In recent years, improvement of reliability by reinforcement using fibers has been attempted. However, since the cost thereof inevitably increases, this attempt has been still at a research level.

On the other hand, materials each primarily comprising a high melting point metal, which is represented by niobium, tantalum, tungsten, or molybdenum, essentially have superior reliability as a material. Among those mentioned above, a material having superior high temperature strength can be obtained. Since these materials essentially have poor oxidation resistance, improvement thereof has been attempted. However, as of today, no sufficient oxidation resistant properties have been successfully imparted to the materials described above.

An attempt has been made in which a material having superior oxidation resistance is applied over a substrate made of a high melting metal material having high temperature strength. For example, see Japanese Unexamined Patent Application Publication No. 5-125519, Japanese Unexamined Patent Application Publication No. 2001-152273, Japanese Unexamined Patent Application Publication No. 2002-327284, and Japanese Unexamined Patent Application Publication No. 2002-155380.

As the oxidation resistant material mentioned above, various alloy materials each containing aluminum may be mentioned. For example, a nickel-base alloy generally represented by NiCrAlY forms a dense aluminum oxide film on a surface thereof in a high-temperature oxidizing atmosphere.

This aluminum oxide film has oxidation resistant properties. However, when being held in a high-temperature oxidizing atmosphere for a long period of time, the depletion of Al occurs under the aluminum oxide film described above, and a layer in which the content of Al is extremely small is generated. In the case in which Al is depleted and cannot be further supplied, for example, when an aluminum oxide film having a low mechanical strength is broken, an aluminum oxide film cannot be further formed, and hence the oxidation resistance degrades. Accordingly, the use of NiCrAlY has been limited to a temperature of approximately 1,100° C. or less.

In an atmosphere at a higher temperature, an aluminum-containing material having a higher melting point, such as an intermetallic compound, NiAl, PtAl, or Mo(SiAl)₂, may be used effectively.

However, when an aluminum-containing material having a high melting point metal as described above is directly applied as a coating material to a substrate made of a high melting point metal material, the diffusion speed of elements suddenly increases, in particular, at a temperature of more than 1,000° C. Hence, a reaction layer or voids are formed between the substrate and the coating material. In addition, cracks caused by thermal cycle start to generate. As a result, the coating material may be damaged or spall off in some cases, and hence a problem of significant degradation in oxidation resistance will occur.

In order to overcome the problems described above, it has been effective to interpose an intermediate layer for preventing the reaction between a substrate and a coating material.

However, in order to sufficiently prevent the reaction between a substrate and a coating material, the intermediate layer must be dense. In addition, a technique is required to effectively form a dense intermediate layer on a common substrate having a complicated shape. For example, see Japanese Unexamined Patent Application Publication No. 2002-288557, Japanese Unexamined Patent Application Publication No. 2002-167638, and L. Shaw and R. Abbaschian, “Journal of American Ceramic Society”, vol. 76, 1993, p. 2305 to 2311.

As the technique described above, heretofore, for example, a method has been investigated which comprises the steps of forming an intermediate layer on a substrate by coating using a chemical vapor deposition (CVD) method, and again coating the intermediate layer with an oxidation resistant material using a plasma spray method.

However, according to the method described above, film forming treatment must be performed twice, and hence it is difficult to easily form a film at a low cost.

In addition, according to the technique described in Japanese Unexamined Patent Application Publication No. 2002-167638, an aluminum foil must be interposed for forming an alumina layer used as a diffusion-barrier layer (intermediate layer). Since it is difficult to provide an aluminum foil uniformly over the entire area between a substrate having an optional shape and an oxidation resistant layer, it is difficult to uniformly form the alumina layer. Hence, a technique has been desired which can be applied to easily and more uniformly form a film having a diffusion-barrier layer at a low cost.

The present invention was made in consideration of the problems described above, and an object of the present invention is to provide a method for easily and uniformly forming a film having a diffusion-barrier layer at an interface with a substrate at a low cost. Particularly, the present invention was made in order to develop an effective technique for imparting oxidation resistant properties to a substrate made of a high melting point metal material or the like.

### SUMMARY OF THE INVENTION

In order to solve the problems described above, the inventors of the present invention carried out intensive research, and found that the following method provides a significantly effective means. The method comprises the steps of forming an oxide layer over the entire surface of a substrate by pretreatment which slightly oxidizes a high melting point metal substrate in advance, and subsequently coating the oxide layer described above with an oxidation resistant material which forms aluminum oxide in a high-temperature oxidizing atmosphere. As a result, the present invention was made based on the finding described above.

### BRIEF DESCRIPTION OF THE DRAWINGS

FIGS. 1(a) to (c) are cross-sectional views showing steps of a film forming method according to an embodiment of the present invention.

FIG. 2 includes scanning electron microscopic images each showing a cross-section of a substrate provided with a film formed in an example of the present invention: (a) shows a reflected electron image, (b) shows an X-ray image with O-Kα, (c) shows an X-ray image with Al-Kα, (d) shows an X-ray image with Si-Kα, and (e) shows an X-ray image with Nb-Lα.

### REFERENCE NUMERALS

1 substrate
2 substrate oxide layer
3 diffusion-barrier layer
4 coating layer.

### DETAILED DESCRIPTION OF THE PRESENT INVENTION

A method for forming a film, according to the present invention, is a method for forming a film having an intermediate layer on a surface of a substrate, the intermediate layer being provided at an interface between the film and the substrate.

The method described above comprises a preliminary oxidation step of forming an oxide layer of the substrate by oxidation thereof, and a coating step of coating the surface with a coating material containing at least one of an alloy and a compound, each of which contains an element forming an oxide having a low enthalpy of formation as compared to that of the oxide of the substrate, whereby the film is formed.

According to the method described above, since the coating material contains an element forming an oxide having a low enthalpy of formation as compared to that of the oxide of the substrate, the oxide of the substrate is returned to the substrate by reduction for obtaining more stabilization. At the same time, the coating material is oxidized to form an intermediate layer made of an oxide between the substrate and the coating material.

That is, only by the preliminary oxidation step and the simple step of forming the layer of the coating material, a film containing the intermediate layer and the coating material layer can be formed. In addition, in the preliminary oxidation step, since the surface of the substrate can be easily and approximately uniformly oxidized, an intermediate layer having a uniform thickness can be easily formed. Furthermore, since the film containing the intermediate layer and the coating material layer can be formed by one layer forming step, cost can be reduced.

In the coating step described above, by imparting energy, the formation of the intermediate layer can be facilitated. For example, by imparting energy in a heating step, the formation of the intermediate layer can be facilitated. In addition, when the coating step comprises a pressure applying step, a dense intermediate layer can be formed.

In the coating step described above, the film is preferably formed by one of hot press sintering, plasma spraying, hot isostatic pressing sintering, and spark plasma sintering. When one of hot press sintering, plasma spraying, hot isostatic pressing sintering, and spark plasma sintering is used, reduction of the oxide of the substrate and oxidation of the compound described above can both be facilitated. In addition, a dense film can be formed. Accordingly, the intermediate layer can be more easily formed.

In the method for forming a film, according to the present invention, the coating material preferably comprises a compound containing aluminum as the compound forming an oxide having a low enthalpy of formation as compared to that of the oxide of the substrate.

According to the method described above, an intermediate layer made of an alumina layer is obtained by oxidation of aluminum. By this alumina layer, the diffusion of atoms between the substrate and the coating material layer can be prevented. That is, the interface between the substrate and the coating material can be stabilized. Hence, the substrate can be protected by the film.

In the method for forming a film, according to the present invention, the coating material preferably comprises at least one selected from the group consisting of an Ni—Al based alloy, a Pt—Al based alloy, an Fe—Al based alloy, an Mo—Si—Al based alloy, a Co—Al based alloy, a Cr—Al based alloy, an Ir—Al based alloy, and an intermetallic compound thereof, each of which forms an alumina layer on a surface of the coating layer at a high temperature of 1,000° C. or more.

According to the method described above, by using the coating material which forms an alumina layer having oxidation resistance on a surface of the coating layer at a high temperature of 1,000° C. or more, the oxidation resistant properties can be imparted to the substrate.

In the method for forming a film, according to the present invention, the coating material more preferably comprises a molybdenum based intermetallic compound represented by Mo(Si₁₋ₓAlₓ)₂.

According to the structure described above, Mo(Si₁₋ₓAlₓ)₂ has a wide composition range of Al, and is thus capable of continuously supplying a sufficient amount of Al to a surface of the coating layer even after an oxidation resistant alumina film is formed thereon.

That is, a coating layer formed from the Mo(Si,Al)₂ described above can be used as an aluminum-reserving layer which effectively functions for a long period of time. Hence, the oxidation resistance of the substrate can be further improved.

In addition, as the coating material described above, a composite material may be used comprising Mo(Si₁₋ₓAlₓ)₂ as a primary component and a remainder which has a lower coefficient of thermal expansion than that of Mo(Si₁₋ₓAlₓ)₂ and which is stable to Mo(Si₁₋ₓAlₓ)₂ at a temperature at which the coating material is used.

According to the composite material described above, an oxidation resistant alumina layer is formed on the surface, and a coating layer having a higher fracture toughness and a lower coefficient of thermal expansion than that of Mo(Si₁₋ₓAlₓ)₂ can be formed. Hence, in coating a high melting point metal base material having a lower coefficient of thermal expansion than that of Mo(Si₁₋ₓAlₓ)₂, a coating layer can be formed which is tougher than Mo(Si₁₋ₓAlₓ)₂ itself and which can further reduce a thermal stress generated while a temperature increases and decreases. That is, as a reliable oxidation-resistant coating material which has superior adhesion and which is more unlikely to spall off, the composite material described above can be used.

As the composite material described above, an Mo(Si₁₋ₓAlₓ)₂-base composite material preferably contains at least one selected from the group consisting, for example, of TaB₂, HfB₂, MoB, and AlN, in which the total of those composite forming components is 30% or less on a volume percent basis.

Those composite forming components are essentially inferior to the Mo(Si₁₋ₓAlₓ)₂ in terms of oxidation resistance. Accordingly, excessive introduction of those composite forming components degrades the oxidation resistance of the composite material. However, when the volume ratio of the composite forming components is 30% or less, particles of the individual components are discontinuously dispersed in the Mo(Si₁₋ₓAlₓ)₂. Even when oxidation of the composite forming components occurs at a surface of the composite material, Mo(Si₁₋ₓAlₓ)₂ present inside forms an oxidation resistant alumina layer. As a result, superior oxidation resistance can be obtained.

Furthermore, as the composite material described above, an Mo(Si₁₋ₓAlₓ)₂ base composite material may be used which contains at least one selected from the group consisting of SiC and mullite, each essentially having superior oxidation resistance. When the volume ratio of the composite forming component is 50% or less, an oxidation resistant alumina layer can be formed.

[Embodiment 1]

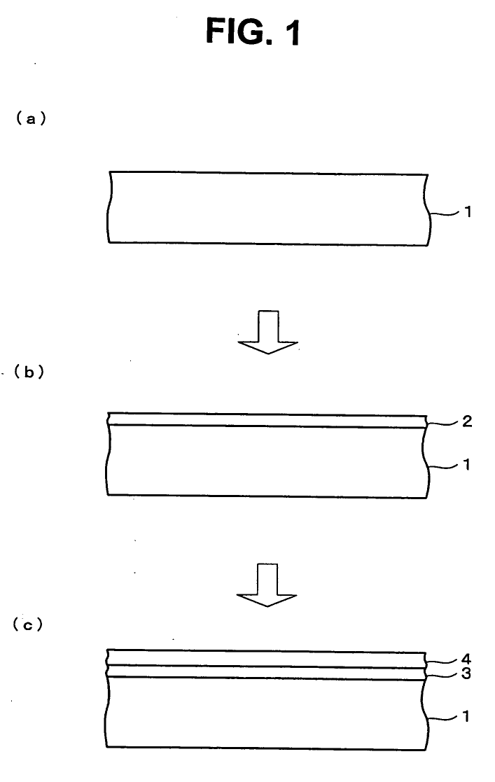

One embodiment of the present invention will be described with reference to FIG. 1.

As shown in FIGS. 1(a) to (c), a method for forming a film having a diffusion-barrier layer (intermediate layer), according to this embodiment, comprises a step (preliminary oxidation step) of forming a substrate oxide layer 2 containing an oxide of a substrate material obtained by oxidizing a surface of a substrate 1, and a step (film forming step) of forming a film comprising a diffusion-barrier layer 3 and a coating layer 4 by coating the substrate oxide layer 2 with a coating material.

In the method described above, oxygen in the substrate oxide layer 2, which is introduced in the preliminary oxidation step, is consumed by oxidation taken place at an interface between the substrate oxide layer 2 and the coating layer 4 which is formed by the following film forming step. As a result, the diffusion-barrier layer 3 is formed.

At the same time, the substrate oxide layer 2 is returned to the substrate 1 by reduction. Hence, on the substrate 1, a film comprising the diffusion-barrier layer 3 and the coating layer 4 is formed. The diffusion-barrier layer 3 becomes a chemically stable material and serves as a dense layer which can prevent, for example, element diffusion between the substrate 1 and the coating layer 4.

Hereinafter, the individual steps will be described in detail.

The preliminary oxidation step is a step of oxidizing the surface of the substrate 1 in an oxidizing atmosphere. In this preliminary oxidation step, the surface of the substrate 1 is oxidized, and hence the substrate oxide layer 2 is formed.

As a material for the substrate 1, a material primarily comprising an element, the oxide of which has a high enthalpy of formation as compared to that of an oxide of the coating material, may be used and is not particularly limited. Typical examples include a metal, an alloy, and a compound.

As a material for the substrate 1, for example, a material primarily comprising Ni, a material primarily comprising Fe, or a material primarily comprising Nb is preferred. More preferably, for example, a high melting point metal material primarily comprising Nb, Ta, W, or Mo, which can be used at a temperature of 1,000° C. or more for a long period of time, may be mentioned.

In addition, as the shape of the substrate 1, any shape may be used. In addition, as is the description of the material for the substrate 1, at least one type of oxide is contained in the substrate oxide layer 2 at the surface of the substrate 1.

In the film forming step described above, the coating layer 4 made of a coating material may be formed on the substrate oxide layer 2, for example, by a pressure sintering method in a reduced-pressure atmosphere, a pressure sintering method (hot press sintering) in an inert atmosphere, a plasma spray method, a hot isostatic pressing (HIP) method, or a spark plasma sintering (SPS) method. In this step, the coating material contains an element forming an oxide having a lower enthalpy of formation than that of the oxide of the material for the substrate. That is, as long as containing at least one element that forms an oxide thereof having a lower enthalpy of formation than that of the oxide of the substrate, the coating material may not be particularly limited. Typical examples for the coating material include a metal, an alloy, and a compound.

As a coating material as described above, for example, an Ni—Al based alloy, a Pt—Al based alloy, an Fe—Al based alloy, an Mo—Si—Al based alloy, a Co—Al based alloy, a Cr—Al based alloy, an Ir—Al based alloy, or a compound thereof may be mentioned.

Among those mentioned above, when oxidation resistant properties are imparted to the substrate 1, a material is preferably used which has sufficient alumina (Al₂O₃) layer-forming capability on the surface thereof at an application temperature.

By this alumina layer, the oxidation resistant properties can be imparted to the substrate. In addition, as the coating material described above, a composite material may be preferably used which comprises Mo(Si,Al)₂ and a compound having a lower coefficient of thermal expansion than that of the Mo(Si, Al)₂.

In addition, the element contained in the coating material, which forms an oxide thereof having a low enthalpy of formation than that of the oxide of the material for the substrate, is not particularly limited. Examples for the element include aluminum (Al), magnesium (Mg), silicon (Si), hafnium (Hf) and the like. Among those mentioned above, aluminum is particularly preferable.

In this film forming step, energy is supplied to the interface between the substrate oxide layer 2 and the coating layer 4, for example, by the hot press sintering, plasma spraying, hot isostatic pressing (HIP) sintering, or spark plasma sintering (SPS), as described above.

An oxide of an element contained in the coating material is formed which has a lower enthalpy of formation than that of the substrate oxide layer 2. The coating material is converted into an oxide at the interface between the substrate oxide layer 2 and the coating layer 4, thereby forming the diffusion-barrier layer 3. By this formation, a film comprising the diffusion blocking layer 3 and the coating layer 4 is formed. For this diffusion-barrier layer 3, Al₂O₃, MgO, SiO₂, HfO₂, or the like may be used. In addition, in particular, when the film forming step comprises a pressure applying step, a denser diffusion-barrier layer 3 can be formed.

Depending on the composition of the substrate 1, the conditions of the preliminary oxidation step described above are preferably set so that the oxidation of the substrate 1 can be stopped in the vicinity of the surface thereof. A temperature for performing the preliminary oxidation is preferably 700° C. or less. In addition, as a period of time for performing the preliminary oxidation, the period for forming; a sufficient amount of the substrate oxide may be sufficient when a sufficient amount of oxygen is introduced for oxidizing the coating material. The oxidation is preferably performed in a short period of time.

Furthermore, the conditions of this preliminary oxidation are determined in considerations of (1) a condition in which after the film forming step is performed, the oxygen thus introduced is substantially consumed for forming the diffusion-barrier layer 3 and is only allowed to remain in the substrate 1 so as not to adversely influence the properties of the substrate 1, and (2) a condition in which a sufficient amount of oxygen is introduced for forming a diffusion-barrier layer 3 having a sufficient thickness in order to prevent the reaction between the substrate 1 and the coating layer 4. Depending on types of substrates, the conditions of the preliminary oxidation may vary. For example, when performed in the air, the preliminary oxidation is preferably performed, in general, at a temperature of 500 to 700° C. for approximately 1 hour or less.

According to the method described above, since a chemically stable diffusion-barrier layer is formed, the problem of chemical compatibility between the substrate and the coating layer can be effectively solved. In addition, by preliminary oxidation of the substrate and film formation thereon performed once, both the diffusion-barrier layer and the coating layer can be formed.

Accordingly, this method can easily form the diffusion-barrier layer and the coating layer on the substrate at a low cost. In addition, by the preliminary oxidation step described above, since the entire surface of the substrate can be substantially uniformly oxidized regardless of the shape thereof, the diffusion-barrier layer can be uniformly formed on the substrate.

[Embodiment 2]

Hereinafter, an embodiment of a forming method of an oxidation resistant film used for a high-temperature application, according to the film forming method of the present invention will be described with reference to FIG. 1 as is the case of embodiment 1. For the convenience of illustration in the figure, the same reference numerals of the constituent elements described in embodiment 1 designate constituent elements having the same functions as those described above, and descriptions thereof will be omitted.

In this embodiment, by using an oxidation resistant material forming an alumina (aluminum oxide) film as a coating material, a film comprising the diffusion-barrier layer 3 and the coating layer 4 is formed. In addition, as a material for the substrate 1, a heat resistant material, such as a high melting point metal material primarily comprising Nb, Ta, W, or Mo, is used. As a coating material, for example, there may be mentioned an Ni—Al based alloy, a Pt—Al based alloy, an Fe—Al based alloy, an Mo—Si—Al based alloy, or a compound thereof, each of which forms an alumina layer on the surface thereof at a high temperature of 1,000° C. or more.

First, preliminary oxidation is performed for a surface of the substrate 1. By this step, the substrate oxide layer (oxide film) 2 made of an oxide of the heat resistant material is formed on the surface of the substrate 1.

Next, the substrate 1 provided with the oxide film 2 on the surface thereof by the preliminary oxidation described above is covered with the coating material described above. Accordingly, the coating layer (oxidation resistant material layer) 4 is formed on the oxide film 2.

For formation of the oxidation resistant material layer 4, for example, there may be mentioned a method which comprises burying the substrate 1 preliminarily oxidized in a powder made of oxidation resistant material and applying a pressure thereto in a reduced-pressure atmosphere for sintering, or a method performed by applying a pressure in an inert atmosphere for sintering.

By the method described above, the oxide film 2 formed on the surface of the substrate 1 is reduced by the oxidation resistant material. At the same time, aluminum of the oxidation resistant material is oxidized, and thus a dense diffusion-barrier layer (intermediate layer) 3 made of aluminum oxide is formed at the interface between the substrate 1 and the oxidation resistant material layer 4. Since this intermediate layer 3 is chemically stable to the substrate 1 and the oxidation resistant material layer 4, the reaction between the substrate 1 and the oxidation resistant material layer 4 can be effectively suppressed.

Accordingly, by the method described above, since the oxidation resistant material layer 4 and the intermediate layer 3 are formed by one layer forming step, a process which can be easily performed at a low cost can be realized.

In addition, the oxidation resistant material layer 4 may be formed by general plasma spraying. When the oxidation resistant material layer 4 is formed by this plasma spraying, at the initial stage of plasma spraying, aluminum contained in the oxidation resistant material reacts with oxygen contained in the oxide film 2, and thus the intermediate layer 3 made of aluminum oxide is formed. Next, on the intermediate layer 3 made of aluminum oxide thus formed, the oxidation resistant material layer 4 is formed.

In addition, as the coating material, Mo(Si,Al)₂ is preferable. Since Mo(Si,Al)₂ has a wide composition range of Al as represented by Mo(Si₁₋ₓ,Alₓ)₂ (where x=0.05 to 0.6), even after an oxidation resistant alumina film is formed on a topmost surface, Mo(Si,Al)₂ has capability of continuously supplying a sufficient amount of Al to the surface. That is, the oxidation resistant material layer 3 formed from Mo(Si,Al)₂ can be used as an aluminum-reservoir layer effectively functioning for a long period of time.

Furthermore, as the coating material, a composite material may be used which comprises Mo(Si,Al)₂ as a primary component and, as a remainder, at least one selected from the group consisting of TaB₂, HfB₂, MoB, AlN, SiC, and mullite. Since those composite materials each contains a compound which has a lower coefficient of thermal expansion than that of Mo(Si,Al)₂ and which is stable to Mo(Si,Al)₂ at a temperature up to approximately 1,500° C., the toughness of Mo(Si,Al)₂, which is a relatively brittle material at room temperature, can be improved, and the coefficient of thermal expansion can also be decreased.

Accordingly, when the composite material described above is used, a significantly effective oxidation resistant coating can be performed for a high melting point metal base material primarily comprising Nb, Ta, Mo, or W, each having a lower coefficient of thermal expansion than that of the Mo(Si,Al)₂.

However, in order not to interfere with the formation of an alumina film having oxidation resistance on a surface, when TaB₂, HfB₂, MoB, or AlN is contained, the total amount thereof must be 30% or less on a volume percent basis, and when SiC or mullite is contained, the total amount thereof must be 50% or less.

Accordingly, the present invention provides a method in which aluminum of high activity contained in the coating material is allowed to react with oxygen in an oxygen-containing layer (oxide layer), whicLoxygen is introduced into the substrate by pretreatment, to reduce the oxygen-containing layer, and at the same time, to form a dense aluminum oxide (alumina) layer between the substrate and the coating layer.

Since this aluminum oxide layer formed at this interface is chemically stable to the substrate and the coating material, the reaction between the substrate and the coating material can be effectively suppressed. Accordingly, over the entire surface of the substrate, the reaction between the substrate and the oxidation resistant material can be prevented.

In this method, the oxidation resistant material layer made of the oxidation resistant material and the aluminum oxide intermediate layer suppressing the diffusion of atoms can be formed by one step.

According to this method described above, because of the formation of the interface between the oxidation resistant material and the substrate covered therewith, the reaction between the substrate and the oxidation resistant material can be prevented.

In addition, the diffusion of elements can also be suppressed. Accordingly, an oxidation resistant film having superior stability for a long period of time can be formed. Hence, for example, this method may be applied to an oxidation-resistant coating method using a material, the use of which in a high-temperature oxidizing atmosphere has been limited because of poor oxidation resistance.

### EXAMPLES

Hereinafter, the present invention will be described in more detail with reference to examples; however, the present invention is not limited thereto.

### Example 1

In this example, raw materials were prepared so as to form a substrate having a composition of 48% of Nb, 12% of Mo, 20% of Ti, 10% of C, and 10% of N on an atomic basis, and were then processed by an arc melting method, thereby forming the substrate. Then, a disc having a diameter of 10 mm and a thickness of 1 mm was obtained using an electric discharge machine and was used as the substrate described above.

In addition, raw materials were prepared so as to have an oxidation resistant coating material having a composition of 33% of Mo, 40.2% of Si, and 26.8% of Al on an atomic basis and were then processed by an arc melting method, thereby forming the oxidation resistant coating material. The oxidation resistant coating material was pulverized into a powder having a particle size of mesh number 250 or less.

First, the substrate was preliminarily oxidized for approximately 30 minutes in a preheated muffle furnace at 600° C. By this preliminary oxidation, a substrate oxide layer made of a yellow oxide was formed on the surface of the substrate.

The conditions (temperature and time) of the preliminary oxidation were determined based on results obtained from an oxidation test performed beforehand. The conditions of the preliminary oxidation varied in accordance with materials for the substrate. For example, in the case of pure Nb, preliminary oxidation was satisfactorily performed at a temperature of 600° C. for 10 minutes.

Next, in a graphite mold having an inner diameter of 12 mm coated with BN(boron nitride), approximately 640 mg of the powdered oxidation resistant material was charged and was then smoothed. Subsequently, the substrate preliminarily oxidized was placed on the powdered oxidation resistant material thus smoothed. Approximately 800 mg of the powdered oxidation resistant material was charged on the substrate preliminarily oxidized, and the substrate preliminarily oxidized was buried.

The mold containing the powdered oxidation resistant material and the substrate preliminarily oxidized was processed by a vacuum hot press sintering by applying a uniaxial pressure of 20 MPa at 1,400° C. for approximately 30 minutes, thereby forming a sample.

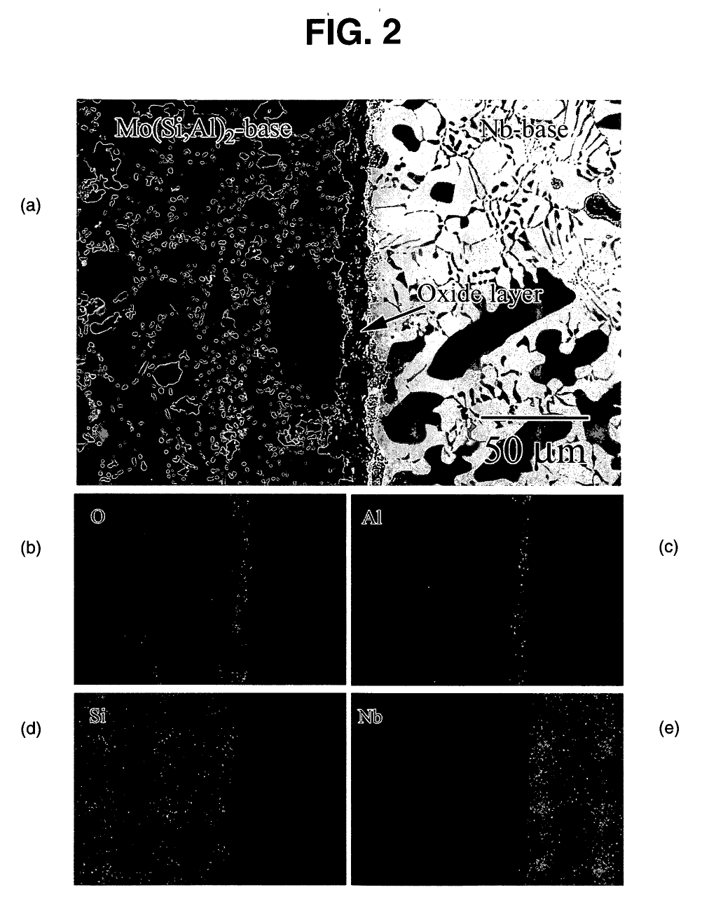

The sample of an oxidation resistant member formed by the vacuum hot press sintering was cut along the thickness direction thereof. After being polished, the surface of the sample obtained by cutting was observed using a scanning electron microscope. A back-scattered electron image and characteristic X-ray images of the substrate and the oxidation resistant material layer are shown in FIG. 2.

As shown in FIG. 2, an oxide layer (intermediate layer) was formed between the substrate containing Nb and the Mo—Si—Al oxidation resistant material layer (layer containing Si). It was believed that this oxide layer was a continuous layer in which only Al and O are present. That is, the oxide layer described above was apparently an alumina layer.

In addition, it was also believed that the oxide layer made of alumina described above was formed at the entire interface between the substrate and the oxidation resistant coating material layer and was a dense layer. Hence, it was confirmed that the oxide layer and the oxidation resistant material layer, described above, could be formed by one film forming step.

### Example 2

In this example, a film forming method using a reduced-pressure plasma spray method will be described.

An Nb base multi-component material plate (Nb.16Si.10Mo.15W on an atomic basis) having a thickness of 2 mm was used as a substrate, and a powdered Mo(Si,Al)₂ base composite material represented by Mo.38.4Si.25.6Al on an atomic basis was used as an oxidation resistant coating material. In this example, the Mo(Si,Al)₂ base composite material contained approximately 10% of Mo₅(Si,Al)₃ on a volume percent basis.

First, the substrate described above was preliminarily oxidized for approximately 30 minutes in a preheated muffle furnace at 600° C., thereby forming an oxide layer on a surface of the substrate.

Next, the substrate described above was placed in a plasma spray device. The inside of a chamber was evacuated, followed by introduction of an Ar gas thereinto to form an Argon atmosphere at a pressure of 20 Torr. The powdered material described above was plasma sprayed. An optimal thickness of the coating layer can be obtained by adjusting various spray conditions. In this example, an oxidation resistant coating layer having a thickness of approximately 700 μm was formed.

A surface of a sample thus formed was examined by an x-ray diffraction experiment. A cross-sectional microstructure in the thickness direction was observed using a SEM. As a result, by a reduced-pressure plasma spray method, a coating material layer made of Mo(Si,Al)₂ as shown in FIG. 2 could also be obtained, and in addition, an alumina intermediate layer was formed at the interface with the substrate.

That is, according to this film forming method, regardless of the type of coating step using a hot press method or a plasma spray method, by only performing preliminary oxidation treatment at a relatively low temperature of approximately 600° C., the intermediate layer can be simultaneously formed when the coating material layer was formed.

### Example 3

The film formation described in examples 1 and 2 can also be performed with an Mo(Si,Al)₂ base composite coating material containing TaB₂, HfB₂, MoB, or AlN.

In this example, an Mo(Si,Al)₂-base composite material containing HfB₂ which is essentially liable to be oxidized at a high temperature will be described. Mo(Si,Al)₂-base composite material exhibiting superior oxidation resistance and being effective in improving the fracture toughness and in decreasing the coefficient of thermal expansion.

Mo(Si_{0.6}Al_{0.4})₂ was selected as a typical composition of the Mo(Si,Al)₂. A material made of only the above compound and composite materials containing 10%, 20%, 30%, and 50% of HfB₂ on a volume percent basis were formed by a pseudo-HIP method using individually powdered compounds as raw materials.

In order to evaluate the oxidation resistant properties, an isothermal oxidation test was performed at 1,400° C. for 100 hours. The changes in weight were continuously recorded during the test. The cross-sectional microstructure was observed after the test was complete. In the case of an Mo(Si_{0.6}Al_{0.4})₂.HfB₂ composite material, HfB₂ present on a surface thereof was oxidized at the initial oxidation stage, and hence an increase of oxidation amount became larger as the content of HfB₂ in the composite material increases.

The changes in weight per unit surface area, for example, from 20 to 100 hours after the start of oxidation, were compared to each other, Mo(Si_{0.6}Al_{0.4})₂ had 15.7 g/m², and Mo(Si_{0.6}Al_{0.4})₂. 10% HfB₂, Mo(Si_{0.6}Al_{0.4})₂.20% HfB₂, Mo(Si_{0.6}Al_{0.4})₂.30% HfB₂, and Mo(Si_{0.6}Al_{0.4})₂.50% HfB₂ had 16.4, 16.5, 16.7, and 62.3 g/m², respectively. That is, when the content of HfB₂ was up to 30%, the change in weight was not significant, and superior oxidation resistant properties can be obtained by alumina layer formation.

However, when the content was increased to 50%, the HfB₂ particles were no longer discontinuously dispersed in Mo(Si_{0.6}Al_{0.4})₂, oxidation of HfB₂ essentially having no oxidation resistance occurred inside. As a result, the alumina layer was not formed so as to have an effective structure. As described above, when a composite forming component having oxidation resistant properties inferior to those of Mo(Si_{0.6}Al_{0.4})₂ was added, the volume percent of the composite forming component must be set to 30% or less on the volume percent basis in order to form an oxidation resistant alumina film layer.

As for the fracture toughness in accordance with an indentation method, Mo(Si_{0.6}Al_{0.4})₂ had 1.8 MPam^{1/2}, and the Mo(Si_{0.6}Al_{0.4})₂.HfB₂ composite materials had 2.0 to 2.8 MPam^{1/2}. In addition, as for the mean coefficient of thermal expansion from 25 to 1,450° C., Mo(Si_{0.6}Al_{0.4})₂ had 9.8×10⁻⁶/K, and Mo(Si_{0.6}Al_{0.4})₂.10% HfB₂, Mo(Si_{0.6}Al_{0.4})₂.20% HfB₂, Mo(Si_{0.6}Al_{0.4})₂.30% HfB₂, and Mo(Si_{0.6}Al_{0.4})₂.50% HfB₂ had 9.5×10⁻⁶, 9.4×10⁻⁶, 9.2×10⁻⁶, and 8.8×10⁻⁶/K, respectively.

As described above, the composite material containing HfB₂ exhibited the capability of forming an oxidation resistant alumina film. At the same time, the effects of improving the fracture toughness and of decreasing the coefficient of thermal expansion were obtained. Accordingly, when used as a coating material, for example, for a high melting point metal base material having a lower coefficient of thermal expansion than that of Mo(Si,Al)₂, the composite material described above is reliable as an oxidation resistant coating material which has superior adhesion, and thus is unlikely to spall off.

Similarly, in an Mo(Si,Al)₂-base composite material containing a composite forming component, such as TaB₂, MoB, or AlN, having oxidation resistant properties inferior to those of Mo(Si,Al)₂, the content of the composite forming component should also be 30% or less on a volume percent basis at which it can be discontinuously dispersed in Mo(Si,Al)₂.

### Example 4

The film formation described in examples 1 and 2 can also be performed with an Mo(Si,Al)₂-base composite coating material containing SiC or mullite which has superior oxidation resistance to that of Mo(Si,Al)₂.

In this example, an Mo(Si,Al)₂-base composite material containing SiC will be described, the Mo(Si,Al)₂-base composite material exhibiting superior oxidation resistance and being effective in improving the fracture toughness and in decreasing the coefficient of thermal expansion.

Mo(Si_{0.6}Al_{0.4})₂ was selected as a typical composition of the Mo(Si,Al)₂, a material made of only the above compound and composite materials containing 10%, 20%, 30%, 40%, and 50% of SiC on a volume percent basis were formed by a hot press method using individually powdered compounds as raw materials.

In order to evaluate the oxidation resistant properties, an isothermal oxidation test was performed at 1,500° C. for 100 hours. The changes in weight were continuously recorded during the test. The cross-sectional microstructure was observed after the test was complete. Since SiC itself essentially has superior oxidation resistant properties, the oxidation resistance of an Mo(Si_{0.6}Al_{0.4})₂.SiC composite material was improved as compared to that of the material made of only Mo(Si_{0.6}Al_{0.4})₂, and the change in weight was slightly decreased as the content of SiC increased.

As for the fracture toughness in accordance with an indentation method, the Mo(Si_{0.6}Al_{0.4})₂-SiC composite materials had 2.2 to 3.4 MPam^{1/2}. It was believed that the effect of improving the toughness could be obtained. In addition, the average coefficient of thermal expansion from 25 to 1,450° C. was approximately linearly decreased to 7.5×10⁻⁶/K.

As described above, when SiC having superior oxidation resistance to that of Mo(Si,Al)₂ was selected as a composite forming component, and a composite material was formed using 50% or less of SiC on a volume percent basis, the effects of improving the oxidation resistance and the fracture toughness and the effect of decreasing the coefficient of thermal expansion can be obtained.

Hence, the composite material described above can be used as a reliable coating material for a high melting point metal base material or the like, having a lower coefficient of thermal expansion than that of Mo(Si,Al)₂, which is more unlikely to spall off and which has superior oxidation resistance.

The present invention is not limited to the embodiments described above. Within the scope described in the claims, various modifications may be performed. In addition, an embodiment obtained by appropriately integrating various technical means described in the embodiments different from each other may also be included in the technical scope of the present invention.

As described above, according to the film forming method of the present invention, a film made of an oxidation resistant material having superior high temperature strength, and comprising an intermediate layer made of aluminum oxide or the like can be formed by only one film forming step, over the entire surface of the substrate.

In addition, for example, by forming the film from an oxidation resistant material capable of forming an aluminum oxide film in a high-temperature oxidizing atmosphere, a member having a superior heat resistant and oxidation resistant film can be formed. Accordingly, for example, the present invention can be applied in an oxidation-resistant coating method using a material, the use of which in a high-temperature oxidizing atmosphere has been limited because of poor oxidation resistance.

1. A method for forming a film on a surface of a substrate, the film having an intermediate layer at an interface with the substrate, the method comprising:
a preliminary oxidation step of forming an oxide layer of the substrate by oxidation thereof; and
a coating step of coating the surface with a coating material containing at least one of an alloy and a compound, each of which contains an element forming an oxide having a low enthalpy of formation as compared to that of the oxide of the substrate.

2. The method for forming a film, according to claim 1, wherein the coating step further comprises a heating step.

3. The method for forming a film, according to claim 1 or 2, wherein the coating step further comprises a pressure applying step.

4. The method for forming a film, according to claim 1, wherein, in the coating step, the film is formed by one of hot press sintering, plasma spraying, hot isostatic pressing sintering, and spark plasma sintering.

5. The method for forming a film, according to one of claims 1, 2 and 4 wherein the coating material comprises a compound containing aluminum as the compound forming an oxide having a low enthalpy of formation as compared to that of the oxide of the substrate.

6. The method for forming a film, according to one of claims 1, 2 and 4, wherein the coating material comprises at least one selected from the group consisting of an Ni—Al based alloy, a Pt—Al based alloy, an Fe—Al based alloy, an Mo—Si—Al based alloy, a Co—Al based alloy, a Cr—Al based alloy, an Ir—Al based alloy, and a compound thereof, each of which forms an alumina layer on a surface of a coating layer at a high temperature of 1,000° C. or more.

7. The method for forming a film, according to claim 6, wherein the coating material comprises a molybdenum based compound represented by Mo(Si₁₋ₓAlₓ)₂, wherein x is from 0.05 to 0.6.

8. The coating material according to claim 1, wherein the coating material is a composite material which comprises 70% or more of Mo(Si₁₋ₓAlₓ)₂ on a volume percent basis and at least one selected from the group consisting of TaB₂, HfB₂, MoB, and AlN, wherein x is from 0.05 to 0.6.

9. The coating material according to claim 1, wherein the coating material is a composite material which comprises 50% or more of Mo(Si₁₋ₓAlₓ)₂ on a volume percent basis and at least one selected from the group consisting of SiC and mullite, wherein x is from 0.05 to 0.6.

10. The method for forming a film, according to one of claim 3 wherein the coating material comprises a compound containing aluminum as the compound forming an oxide having a low enthalpy of formation as compared to that of the oxide of the substrate.

11. The method for forming a film, according to one of claim 3, wherein the coating material comprises at least one selected from the group consisting of an Ni—Al based alloy, a Pt—Al based alloy, an Fe—Al based alloy, an Mo—Si—Al based alloy, a Co—Al based alloy, a Cr—Al based alloy, an Ir—Al based alloy, and a compound thereof, each of which forms an alumina layer on a surface of a coating layer at a high temperature of 1,000° C. or more.

12. The method for forming a film, according to one of claim 5, wherein the coating material comprises at least one selected from the group consisting of an Ni—Al based alloy, a Pt—Al based alloy, an Fe—Al based alloy, an Mo—Si—Al based alloy, a Co—Al based alloy, a Cr—Al based alloy, an Ir—Al based alloy, and a compound thereof, each of which forms an alumina layer on a surface of a coating layer at a high temperature of 1,000° C. or more.

13. The method for forming a film, according to claim 11, wherein the coating material comprises a molybdenum based compound represented by Mo(Si₁₋ₓAlₓ)₂, wherein x is from 0.05 to 0.6.

14. The method for forming a film, according to claim 12, wherein the coating material comprises a molybdenum based compound represented by Mo(Si₁₋ₓAlₓ)₂, wherein x is from 0.05 to 0.6.
